(19) United States
(12) Patent Application Publication
(10) Pub. No.: US 2007/0252721 A1
(43) Pub. Date: Nov. 1, 2007

(54) Spatial Interaction System

(75) Inventor: Lucas Jacobus Franciscus Geurts, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,776

(22) PCT Filed: May 31, 2005
(86) PCT No.: PCT/IB05/51770

§ 371 Date: Nov. 29, 2006

(30) Foreign Application Priority Data
Jun. 7, 2004 (EP) 04102558.6

(51) Int. Cl. G05B 19/04

(52) U.S. Cl. 340/825.22

(57) ABSTRACT

The present invention relates to a remote control device and a computer program product for control of a plurality of consumer-electronic devices. The remote control device comprises a user interface and means for determining an orientation of the remote control device relative to at least one of the consumer-electronic devices. The remote control device further comprises means for adapting the user interface based on said orientation of the remote control device.

### FIELD OF THE INVENTION

The invention relates to a method, device and computer program product for remote control of a plurality of consumer-electronic devices.

### BACKGROUND OF THE INVENTION

As more and more consumer-electronic devices are used in the home environment, an ever increasing number of remote controls come along with them. Although there are programmable multi-functional remote controls, most such devices are quite cumbersome to program and use. Moreover, they often require a memorized interaction style because the programmed interaction keys do not correspond fully logically to the assigned functions. More sophisticated remote controls, such as the Philips ProntoPro, provide a multi-functional remote control having a color display screen and programmable buttons and the facility to set up, change, and personalize the user interface.

Prior patent application US 2003 0 071 104 A1 relates to a network system for remote control of objects, such as electric appliances. The system comprises a video camera monitoring objects to be controlled and detecting only light of a particular wavelength range. A remote controller comprises a light pointer of said particular wavelength range. A control unit is arranged to process an output signal from the video camera to detect any one or more of the objects, indicated by the pointer. The control unit is also arranged to receive an operation signal from the remote controller, which signal is associated with the remote controlling operation performed on the indicated object, and to supply a control signal in accordance with the operation signal through a network to the object indicated by the pointer, so that this object can be remotely controlled by the remote controller. In a particular embodiment, a projector is additionally provided to display an operation panel for the object to be controlled, so that the object can be remotely controlled by pointing on the operation panel.

Although this provides a system for selecting objects to be controlled by simply directing a remote control towards the objects, a drawback of the above-described system according to US 2003 0 071 104 A1 is that it will soon become complex and quite expensive if one is to provide simultaneous camera coverage of a full home environment and at the same time provide the possibility of presenting an operation panel adjacent to each object being controlled. Moreover, as cameras and projectors are more or less stationary in their setup, the system according to US 2003 0 071 104 A1 is not very suitable in an environment comprising non-stationary objects to be controlled.

### OBJECT AND SUMMARY OF THE INVENTION

It is an object of the invention to obviate the drawbacks of the prior art and to provide a device for remote control of a plurality of consumer-electronic devices.

According to the invention, this object is realized in that the remote control device comprises a user interface, means for determining an orientation of the remote control device relative to at least one consumer-electronic device and means for adapting the user interface on the basis of said orientation of the remote control device.

The user interface may comprise, for example, a regular display screen, a touch screen, a loudspeaker and/or one or more keys. Adapting the user interface may comprise, for example, changing an image displayed on a display screen. The means for adapting the user interface may be implemented in software and/or in hardware. The remote control device may be capable of controlling moving devices, like robots and remotely controllable cars, planes and boats. Other examples of consumer-electronic devices that may be controllable by the remote control device are televisions, audio receivers, audio amplifiers, satellite receivers, cable decoders, terrestrial receivers, recording devices, game consoles, optical disc players, etc. The envisaged object can be achieved, thus providing a flexible way of controlling a plurality of consumer-electronic devices in a dynamic environment using institutive graphical user interfaces.

The remote control device may further comprise means for identifying a specific one of the consumer-electronic devices on the basis of said orientation of the remote control device and presenting controls of said specific one consumer-electronic device on a display screen of said user interface. For example, when a user points the remote control device to a television, a touchscreen of the remote control device may display channel up and down buttons, a mute button, a teletext button, an on/off button, etc.

The means for determining the orientation of the remote control device relative to at least one consumer-electronic device may be capable of determining a position and a reference orientation of the remote control device and a position of said at least one consumer-electronic device. The means for determining said orientation may comprise, for example, a receiver receiving the position of at least one consumer-electronic device from at least one consumer-electronic device. A consumer-electronic device or an accessory device near the consumer-electronic device may be equipped with a GPS-receiver for determining its position and a wireless transmitter, e.g. IR or RF, for transmitting its position to the remote control device. Instead of using GPS, the consumer-electronic device or the accessory device may be capable of receiving signals from other references, e.g. locally placed beacons, to triangulate its position. The remote control device may also be capable of determining its position by triangulation. It may also comprise a compass for determining a magnetic reference or may be capable of determining a reference with respect to locally placed beacons.

The remote control device may further comprise means for compiling and presenting an interactive map of the plurality of consumer-electronic devices on a display screen of said user interface on the basis of said orientation of the remote control device. This may allow a user, for example, to draw an imaginary line between the middle of the display screen of the remote control device and the consumer-electronic device he wishes to control, so that he can quickly locate a representation of the consumer-electronic device, e.g. a text label or a picture, on the interactive map.

The interactive map may further be based on a position of at least one consumer-electronic device. This enables a user to quickly pinpoint a consumer-electronic device on the imaginary line if multiple devices are on or near this line. A position may be two or three-dimensional. The interactive map may also be two or three-dimensional. At least one consumer-electronic device may be represented by a picture of said at least one consumer-electronic device. A picture may be, for example, a drawing or a photograph. This enables a user to control a consumer-electronic device without knowing its label.

The remote control device may further comprise means for presenting a graphical representation of a media content item at an initial position on said interactive map, means for giving said graphical representation of a media content item a simulated movement towards a graphical representation of a particular consumer-electronic device, and means for directing a physical representation of said media content item towards said particular consumer-electronic device. This enables, for example, a user to quickly reproduce the media content item without first having to select the consumer-electronic device.

The remote control device may further comprise means for presenting a user interface on said display screen for controlling said particular consumer-electronic device, when said media content item is accepted by said particular consumer-electronic device. Advantageously, the user interface only needs to comprise controls that are useful for controlling reproduction of said media-content item, e.g. no picture-in-picture button needs to be displayed when playing music files.

The remote control device may further comprise means for returning said graphical representation of said media content item to said initial position, when said media content item is rejected by said consumer-electronic device. This enables a user to quickly discover whether a certain consumer-electronic device can be used to reproduce a selected media content item.

In a further aspect of the invention, a computer program allows a programmable device to function as the remote control device of the invention. A computer program product comprising the computer program may be directly loadable into the internal memory of the programmable device. The computer program product may be stored on a computer-readable storage medium.

WO0124387, incorporated herein by reference, describes a programmable remote control unit which is capable of initiating retrieval of a control configuration from a storage device external to the unit. The unit comprises a memory for storing the retrieved control configuration; a display for displaying icons representing the configuration; and a touch screen for entering a selection based on the displayed icons. The storage device is a component of a consumer-electronic apparatus. By storing or backing up the control configuration for a specific apparatus in the apparatus itself, the remote control unit is made universally programmable.

U.S. Pat. No. 6,563,430, incorporated herein by reference, describes a user control interface that is location-dependent. Context control parameters are associated with location, and the user control interface is customized to the context within which the device is being operated. The control interface includes the presentation of context-sensitive information and the communication of corresponding context-sensitive user commands via the interface. The location is determined by using any number of commonly available techniques, such as direct entry, infrared sensors and active badges for relative positioning, as well as the conventional absolute positioning devices such as LORAN and GPS. The device preferably communicates with a remote information source which provides the context-sensitive control information. The remote information source may be a home network server, an Internet server, a public service network, or another communication network.

WO0123994, incorporated herein by reference, describes a handheld remote control which has a wireless modem sending an identifier to a server on the Internet. The server has a look-up table associating the identifier with a URL. The URL specifies a CGI program on another machine on the Internet. The machine controls equipment through execution of the CGI program.

### BRIEF DESCRIPTION OF THE DRAWING

In the drawing, wherein identical reference numerals denote similar elements throughout the several views,

FIG. 1 shows a principle of operation of a device according to the invention, and

FIG. 2 shows an interactive map of graphical representations of consumer-electronic devices within the control range.

Other objects and features of the invention will become apparent from the following detailed description with reference to the accompanying drawing. It is to be noted, however, that the drawing is designed solely for purposes of illustration and not as a definition of the limits of the invention, for which reference should be made to the appended claims. It should further be noted that the Figures are not necessarily drawn to scale and that, unless otherwise indicated, they are merely intended to conceptually illustrate the structures and procedures described hereinafter.

### DESCRIPTION OF EMBODIMENTS

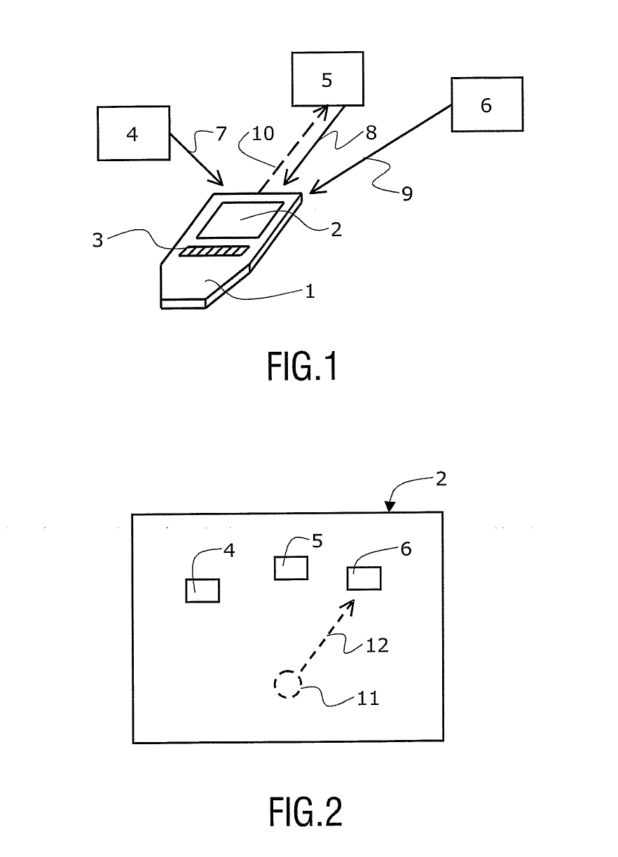

FIG. 1 illustrates schematically a device for remote control of a plurality of consumer-electronic devices 4, 5, 6. The device comprises a hand-held remote control 1 having a display screen 2. The remote control 1 is further provided with means for user interaction, which means may e.g. comprise means integrated with the display screen 2 of the remote control 1 for providing a touch screen functionality, and/or programmable function keys 3. Furthermore, the remote control has directional properties, such that it enables a user to aim and direct it in a certain direction.

The device further comprises means for compiling real-time three-dimensional positioning and orientation information from consumer-electronic devices 4, 5, 6 within the control range of the remote control 1, and from the remote control 1. This is realized by providing real-time three-dimensional positioning and orientation information to the consumer-electronic devices 4, 5, 6 intended to be controlled by means of the remote control 1 of the device. For positioning, e.g. a local in-door ultrasound system can be used. The orientation can be established by using a digital compass or more sophisticated three-dimensional sensing techniques. The consumer-electronic devices 4, 5, 6 can then be arranged to communicate their position and orientation to the hand-held remote control 1. In this way, the hand-held remote control 1 can build an up-to-date spatial three-dimensional model of the consumer-electronic devices 4, 5, 6 within the control range of the remote control 1.

Furthermore, means are provided for establishing a position and direction of the remote control 1 with respect to the consumer-electronic devices 4, 5, 6. Means are also provided for using the positioning and orientation information to identify any one consumer-electronic device 4, 5, 6 which is indicated by the remote control 1 being directed substantially towards it, e.g. in the direction indicated by the dashed arrow 10 pointing at the consumer-electronic device 5, as shown in FIG. 1. When a consumer-electronic device, such as the consumer-electronic device 5 has been identified, means for presenting a user interface on the display screen 2 are activated to allow control of the identified consumer-electronic device.

In an additional embodiment, the device further comprises means for interpreting the positioning and orientation information, and means for compiling and selectively presenting an interactive map of graphical representations of consumer-electronic devices within the control range on the display screen 2, as illustrated in FIG. 2.

In a further embodiment, the device comprises means for presenting a map of physical structures on the display screen 2, which map overlays the interactive map and houses the consumer-electronic devices 4, 5, 6, such as the walls, ceilings and floors of the rooms in which the consumer-electronic devices 4, 5, 6 are situated. Furthermore, means are provided to enable the remote control 1 to distinguish between spaces, e.g. rooms, delimited by these physical structures. It is envisaged that this distinguishing information can be used, for example, for selecting appropriate communication modes so as to allow control of consumer-electronic devices 4, 5, 6 that are fully or partially obscured by the physical structures.

As is also illustrated in FIG. 2, in a further embodiment, the device comprises means for presenting a graphical representation of a media content item 11 at an initial position on the interactive map. Means are also provided for giving the graphical representation of a media content item 11 a simulated movement towards a graphical representation of a particular consumer-electronic device, e.g. towards the consumer-electronic device 6 along the path indicated by the dashed arrow 12, as illustrated in FIG. 2.

Means for directing a physical representation of the media content item 11 towards the particular consumer-electronic device 4, 5, 6 are arranged to be activated when they are given such a simulated movement. Furthermore, means are provided for presenting a user interface on the display screen 2 for controlling the particular consumer-electronic device 4, 5, 6, when the media content item 11 is accepted by the particular consumer-electronic device 4, 5, 6, and means for returning the graphical representation of the media content item 11 to the initial position, when the media content item 11 is rejected by the consumer-electronic device 4, 5, 6.

In a further embodiment, the means for user interaction comprises means integrated with the display screen 2 of the remote control 1 for providing it with a touch-screen functionality.

A method of allowing remote control of a plurality of consumer-electronic devices 4, 5, 6 using a hand-held remote control 1 having a display screen 2, and means for user interaction and directional properties comprises the steps of: providing real-time three-dimensional positioning and orientation information to the consumer-electronic devices 4, 5, 6 and the remote control 1; ensuring communication to the remote control 1 of the positioning and orientation information from consumer-electronic devices 4, 5, 6 within the control range of the remote control 1; directing the remote control 1 towards one of the plurality of consumer-electronic devices 4, 5, 6; identifying one consumer-electronic device indicated through the directing operation using the positioning and orientation information; and presenting a user interface on the display screen 2 to allow control of the identified one consumer-electronic device.

Using the above method, a user can “tune” in to a consumer-electronic device. If the hand-held remote control 1 is directed towards the consumer-electronic device, the graphical user interface controls of this device, e.g. buttons and sliders, are displayed on the display screen 2 of the hand-held remote control 1, thus establishing a link for interactive control of the consumer-electronic device.

In a further embodiment, the method further comprises the steps of: interpreting the positioning and orientation information; and compiling and selectively presenting to the display screen 2, as illustrated in FIG. 2, an interactive map of graphical representations of consumer-electronic devices 4, 5, 6 within the control range.

In a further embodiment, the method also comprises the steps of: presenting a map of physical structures on the display screen 2, which map overlays the interactive map and houses the consumer-electronic devices 4, 5, 6, such as the walls, ceilings and floors of the rooms in which the consumer-electronic devices 4, 5, 6 are situated; and distinguishing between spaces, e.g. rooms, delimited by these physical structures. Further steps can be envisaged, such as using this distinguishing information, for example, for selecting appropriate communication modes so as to allow control of consumer-electronic devices 4, 5, 6 that are fully or partially obscured by the physical structures.

In a further embodiment, the method comprises the steps of: presenting a graphical representation of a media content item 11 at an initial position on the interactive map; giving the graphical representation of a media content item 11 a simulated movement towards a graphical representation of a particular consumer-electronic device 4, 5, 6; directing a physical representation of the media content item towards the particular consumer-electronic device 4, 5, 6; , presenting a user interface (not shown) on the display screen 2 for controlling the particular consumer-electronic device, when the media content item is accepted by the particular consumer-electronic device 4, 5, 6; and returning the graphical representation of the media content item 11 to the initial position, e.g. the position as illustrated in FIG. 2, when the media content item 11 is rejected by the particular consumer-electronic device.

The addition of these last-mentioned method steps allows a user interaction style in which a content item 11 is “thrown” from the display screen 2 in the direction of a consumer-electronic device 4, 5, 6. If there is a consumer-electronic device 4, 5, 6 on the pathway of the content item 11, it is “caught” by the consumer-electronic device 4, 5, 6 and is accepted and played, e.g. a video clip or a music playlist. If the content item 11 is accepted, media controls, e.g. to start or stop video playback, will be accessible on the display screen 2 of the hand-held remote control 1. If no consumer-electronic device 4, 5, 6 is encountered, the content item 11 will return to the display screen 2, just like a boomerang returning to the person throwing it. To initiate this action, the user can e.g. drag the graphical representation of the media content item 11 on the display screen 2, e.g. a touch screen, and give the graphical representation of the media content item 11 speed and direction. This speed and direction can then be used to determine a virtual path as the user releases the object.

It is envisaged that the above method can be implemented by means of a computer program, which is stored on a computer-readable storage medium and is suitable to perform the above method when it is run on a digital computer.

It is further envisaged that the above method can be implemented by means of a computer program product, which is directly loadable into the internal memory of a digital computer and comprises a computer program for performing the above method when the program is run on the computer.

As illustrated above, the invention relates to a method, device and computer program product for remote control of a plurality of consumer-electronic devices 4, 5, 6, using a hand-held remote control 1 having a display screen 2, as well as means for user interaction and directional properties. Via the remote control 1, which is aware of its position and direction with respect to consumer-electronic devices 4, 5, 6 within the control range, a consumer-electronic device can be identified automatically, and a suitable graphical user-interface for its control can be presented on the display screen 2 of the remote control 1 in response to the remote control being directed towards a particular device.

It is further envisaged that the above-described remote control 1 can be arranged to communicate with the consumer-electronic devices 4, 5, 6 by means of any current or future communication technology which is suitable for remote control applications, e.g. infrared light communication technology, radio frequency communication technology, such as Bluetooth™ communication technology or Wireless Local Area Network (WLAN) communication technology. Furthermore, device discovery mechanisms can be used to scan the (wireless) environment at given intervals for detecting and compiling information about consumer-electronic devices 4, 5, 6 within the control range. Typical technologies for achieving device discovery are Bluetooth™ device scanning and Universal Plug & Play (UPnP) on a WiFi network.

While fundamental novel features of the invention as applied to a preferred embodiment thereof have been shown, described and elucidated, it will be evident that those skilled in the art may omit, replace, or change the form and details of the devices described hereinbefore, and modify their operation, without departing from the scope of the invention. For example, it is expressly to be noted that any combination of those elements and/or method steps that perform substantially the same function in substantially the same way to achieve the same results is within the scope of the invention. Moreover, it should be noted that structures and/or elements and/or method steps shown and/or described in connection with any disclosed form or embodiment of the invention may be incorporated in any other disclosed or described or suggested form or embodiment as a general matter of design choice. It is therefore understood to be limited only as indicated by the scope of the appended claims in which any reference sign shall not be construed as limiting the scope of the claims.

1. A remote control device for controlling a plurality of consumer-electronic devices, the device comprising:
a user interface;
means for determining an orientation of the remote control device relative to at least one consumer-electronic device; and
means for adapting the user interface on the basis of said orientation of the remote control device.

2. The device of claim 1, characterized in that if further comprises means for identifying a specific one of the consumer-electronic devices on the basis of said orientation of the remote control device and presenting controls of said specific one consumer-electronic device on a display screen of said user interface.

3. The device of claim 1, characterized in that the means for determining the orientation of the remote control device relative to at least one consumer-electronic device is capable of determining a position and a reference orientation of the remote control device and a position of said at least one consumer-electronic device.

4. The device of claim 1, characterized in that it further comprises means for compiling and presenting an interactive map of the plurality of consumer-electronic devices on a display screen of said user interface on the basis of said orientation of the remote control device.

5. The device of claim 4, characterized in that the interactive map is further based on a position of at least one consumer-electronic device.

6. The device of claim 4, characterized in that at least one consumer-electronic device is represented by a picture of said at least one consumer-electronic device.

7. The device of claim 4, characterized in that it further comprises:
means for presenting a graphical representation of a media content item at an initial position on said interactive map;
means for giving said graphical representation of a media content item a simulated movement towards a graphical representation of a particular consumer-electronic device; and
means for directing a physical representation of said media content item towards said particular consumer-electronic device.

8. The device of claim 7, characterized in that it further comprises means for presenting a user interface on said display screen for controlling said particular consumer-electronic device, when said media content item is accepted by said particular consumer-electronic device.

9. The device of claim 7, characterized in that it further comprises means for returning said graphical representation of said media content item to said initial position, when said media content item is rejected by said consumer-electronic device.

10. A computer program, which is stored on a computer-readable storage medium, for allowing a programmable device to function as the remote control device of claim 1.

11. A computer program product, which is directly loadable into the internal memory of a programmable device and comprises a computer program for allowing the programmable device to function as the remote control device of claim 1.
